(19) United States
(12) Patent Application Publication
(10) Pub. No.: US 2026/0002957 A1
(43) Pub. Date: Jan. 1, 2026

(54) CANTILEVER MOTION SENSOR

(71) Applicant: TEXAS INSTRUMENTS INCORPORATED, Dallas, TX (US)

(72) Inventors: Michael Szelong, Freising (DE); Bichoy Bahr, Allen, TX (US); Udit Rawat, Allen, TX (US)

(21) Appl. No.: 18/759,509

(22) Filed: Jun. 28, 2024

(51) Int. Cl. G01P 15/135; G01P 15/09; G01P 15/12

(52) U.S. Cl. CPC G01P 15/135; G01P 15/09; G01P 15/123

(57) ABSTRACT

A motion sensor is described including a semiconductor substrate including a cavity; a mass portion over a bottom of the cavity; a beam coupled between the mass portion and a side of the cavity; and a pair of sensing elements at a distal end of the beam away from the mass portion and being part of the beam or on two opposing sides of the beam. The motion sensor further includes a processing circuit coupled to the pair of sensing elements and configured to receive first signals from the pair of sensing elements and provide a second signal representing a measurement of a motion of the motion sensor based on the first signals.

### BACKGROUND

A motion sensor can sense a direction and/or a magnitude of a motion (e.g., distance, speed, or acceleration), and generate a signal representing the sensed motion. Various properties of the motion sensor, such as its sensitivity, directionality, frequency response, etc., can impact the application of the motion sensor.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1A is a schematic illustrating a side view of a motion sensor with a swingable load mass, in accordance with at least one example.

FIG. 1B is a schematic illustrating a perspective view of the motion sensor, in accordance with at least one example.

FIG. 1C is a schematic illustrating a top view of the motion sensor, in accordance with at least one example.

FIG. 2 is a schematic illustrating the motion sensor with a processing circuit, in accordance with at least one example.

FIG. 3 is a schematic illustrating a perspective view of a cantilever beam, in accordance with at least one example.

FIG. 4 is a plot illustrating stress of the cantilever beam, in accordance with at least one example.

FIG. 5 is a schematic of a motion sensor with two parallel cantilever beams, in accordance with at least one example.

FIG. 6A is a schematic illustrating a side view of a motion sensor with a swingable mass and a hole region, in accordance with at least one example.

FIG. 6B is a schematic illustrating a perspective view of the motion sensor of FIG. 6A with sensing elements on branches adjacent to the hole region, in accordance with at least one example.

FIG. 6C is a schematic illustrating a perspective view of a portion of the motion sensor with sensing elements on top of a beam of the motion sensor of FIG. 6A, in accordance with at least one example.

FIG. 7A is a schematic illustrating a top view of a pair of motion sensors with bumpers configured to hinder swing above a threshold, in accordance with at least one example.

FIG. 7B is a schematic illustrating a side view of an individual motion sensor which is configured to swing in the z-direction, in accordance with at least one example.

FIG. 7C is a schematic illustrating a side view of an individual motion sensor with mass added under the cantilever and above the load mass, in accordance with at least one example.

FIG. 7D is a schematic illustrating a side view of an individual motion sensor with mass added under and above the load mass, in accordance with at least one example.

FIG. 8A is a schematic illustrating a top view of a pair of motion sensors with resistive sensing bridges, in accordance with at least one example.

FIG. 8B is a schematic illustrating a portion of an individual sensing bridge, in accordance with at least one example.

FIG. 9 is a schematic illustrating gyration measurement of the pair of motion sensors of FIG. 8A around a z-axis away from a center of the pair of motion sensors, in accordance with at least one example.

FIG. 10 is a schematic of a motion sensor with four orthogonally placed beams with swingable masses, in accordance with at least one example.

FIG. 11 is a schematic illustrating process regions for the motion sensor of FIG. 1A, in accordance with at least one example.

FIG. 12 is a schematic illustrating a motion sensor with a silicon protrusion to adjust a cavity gap between a swingable mass and the silicon protrusion to control oscillation of a cantilever, in accordance with at least one example.

FIGS. 13A-F are schematics illustrating process flows for forming a unidirectional motion sensor, in accordance with some examples.

FIG. 14A is a schematic illustrating a perspective of a multi-directional motion sensor, in accordance with at least one example.

FIG. 14B is a schematic illustrating a top view of the multi-directional motion sensor of FIG. 14A, in accordance with at least one example.

FIG. 15 is a schematic illustrating a perspective view of a multi-directional motion sensor with a larger center mass and shorter and wider sensor beams than FIGS. 14A-B, in accordance with at least one example.

FIG. 16 is a schematic illustrating a top view of a multi-directional motion sensor with over-shock stoppers, in accordance with at least one example.

FIGS. 17A-C are schematics illustrating cross-sectional views of the over-shock stoppers and their placement in a multi-directional motion sensor, in accordance with at least one example.

FIG. 18 is a plot illustrating an audible range of a multi-directional motion sensor configured as a voice accelerometer, in accordance with at least one example.

FIG. 19 is a flowchart of a method of forming a motion sensor, in accordance with at least one example.

### SUMMARY

In at least one example, an apparatus is provided which comprises a motion sensor including a semiconductor substrate having a cavity and a mass portion over a bottom of the cavity. In at least one example, the motion sensor comprises a beam coupled between the mass portion and a side of the cavity. In at least one example, the motion sensor comprises a pair of sensing elements at a distal end of the beam away from the mass portion and being part of the beam or on two opposing sides of the beam. In at least one example, the apparatus comprises a processing circuit coupled to the pair of sensing elements and configured to receive first signals from the pair of sensing elements. In at least one example, the processing circuit is configured to provide a second signal representing a measurement of a motion of the motion sensor based on the first signals.

In at least one example, an apparatus is provided which comprises a unidirectional shock sensor including a substrate having a cavity and a mass portion over a bottom of the cavity. In at least one example, the unidirectional shock sensor comprises a beam coupled between the mass portion and a side of the cavity. In at least one example, the unidirectional shock sensor includes a pair of sensing elements at a distal end of the beam away from the mass portion and being part of the beam or on two opposing sides of the beam. In at least one example, the apparatus comprises a processing circuit coupled to the pair of sensing elements and configured to receive first signals from the pair of sensing elements. In at least one example, the processing circuit is configured to provide a second signal representing a measurement of a motion of the unidirectional shock sensor based on the first signals.

In at least one example, an apparatus is provided which comprises a voice accelerometer including a substrate having a cavity and a mass portion adjacent to the cavity. In at least one example, the voice accelerometer includes a beam coupled between the mass portion and a side of the cavity. In at least one example, the voice accelerometer includes a pair of sensing elements on the first beam near the mass portion and away from the side of the cavity. In at least one example, the apparatus comprises a processing circuit coupled to the pair of sensing elements and configured to receive a first signal from the pair of sensing elements, the first signal representing a measurement of a motion of the voice accelerometer. In at least one example, the processing circuit is configured to provide an audio signal based on the first signal.

### DETAILED DESCRIPTION

In at least one example, a unidirectional motion sensor (herein also referred to as a unidirectional shock sensor or a vibration sensor) comprises a substrate including a cavity, a mass portion over a bottom of the cavity, and a beam coupled between the mass portion and a side of the cavity. The size of the mass portion, the width of the beam, shape of the beam (e.g., tapered, or rectangular), and/or the thickness of the beam can be modified to change the sensitivity of the motion sensor and its direction of sensitivity. For instance, by making the beam wider in an x-y plane relative to the thickness of the beam (e.g., beam is much wider than thick), the mass swings in a z-direction. In another example, by making the beam narrow in the x-y plane with respect to thickness of the beam (e.g., beam is much thicker than wide), the mass swings in the x-y plane. The beam and the mass portion together form a cantilever.

In at least one example, the beam comprises piezoelectric material that may be arranged in a bimorph configuration. In at least one example, the unidirectional motion sensor includes a pair of sensing elements at a distal end of the beam away from the mass portion and being part of the beam or on two opposing sides of the beam. In at least one example, a processor circuitry is coupled to the pair of sensing elements and configured to receive first signals from the pair of sensing elements. The processor circuitry provides a second signal representing a measurement of a motion of the unidirectional motion sensor based on the first signals. In at least one example, the beam comprises a piezoresistive bridge. The pair of sensing elements are part of the piezoresistive bridge. In at least one example, several unidirectional motion sensors are arranged orthogonal to one another to detect motion in various directions simultaneously. In at least one example, bumpers are formed near or adjacent to the beams to reduce oscillations of the beams. With such arrangements, each unidirectional shock sensor can sense motion in a particular direction independently from other unidirectional shock sensors. This makes processing simple and measurement accurate, since the outputs of other unidirectional shock sensors do not affect the output of a particular unidirectional shock sensor, and there is no need for filtering or other processing to separate the outputs of the unidirectional shock sensors.

In at least one example, an accelerometer is provided that can measure acceleration in three orthogonal directions using a movable load mass. In at least one example, the accelerometer comprises beams having first ends attached to the moveable load mass and second ends connected to a substrate, where a cavity in the substrate is under the beams. One or more sensing elements are placed on an individual beam near the movable load mass and away from the cavity. The beams may comprise piezoelectric material or piezoresistive material. Acceleration along the axes is mechanically transformed into rotation of the moveable load mass. Depending on the movement or rotation of the movable load mass, the beams experience stress which is sensed by the one or more sensing elements. The beams bend differently depending on the direction of acceleration. More mass increases sensitivity of the accelerometer. In at least one example, the mass can include a center portion and extension portions from corners and sides of the center portion to fill up spaces between the beams, which can increase the total swingable mass to further increase the sensitivity of the accelerometer while maintaining the footprint of the accelerometer. In at least one example, an accelerometer can include pairs of beams arranged in parallel in an x-y plane and separated by a portion of the moveable load mass. Such an arrangement of the pairs of beams makes the accelerometer insensitive to gyration around the z-axis. In at least one example, there is no load mass between the pair of beams. The pair of beams can reduce the impact of gyration alone. In at least one example, the accelerometer includes over shock stoppers that prevent the beams from breaking upon impact of the accelerometer with an object. In at least one example, the beams are tapered, which increases signal-to-noise ratio (SNR).

The accelerometer of various examples can be used as a voice accelerometer. A voice accelerometer can sense direction and speed of acceleration of the accelerometer caused by sound vibration and convert the sensed acceleration into electrical signals representing the sound vibration. In at least one example, the voice accelerometer can be attached to a body part of a person that can vibrate as the person speaks, and the voice accelerometer, as well as the load mass, can move due to the vibration. The voice accelerometer can sense the motion of the load mass and convert the motion into electrical signals representing the voice/speech of the person, while being insensitive (or less sensitive) to sound transmitted through air. As such, the voice accelerometer can detect voice from the speaker while removing (or at least attenuating) external environmental noise. The voice accelerometer can include stiffer and shorter beams, which allow the resonant frequency of the accelerometer to be outside an audible frequency range. Such arrangements allow for a flat response in an audio range of interest (e.g., resonance frequency is at 7 kHz and the application is interested in an audio range up to 4 kHz) to facilitate the sensing and conversion of human voice into electrical signals.

Here, the same reference numbers or other reference designators are used in the drawings to designate the same or similar (either by function and/or structure) features.

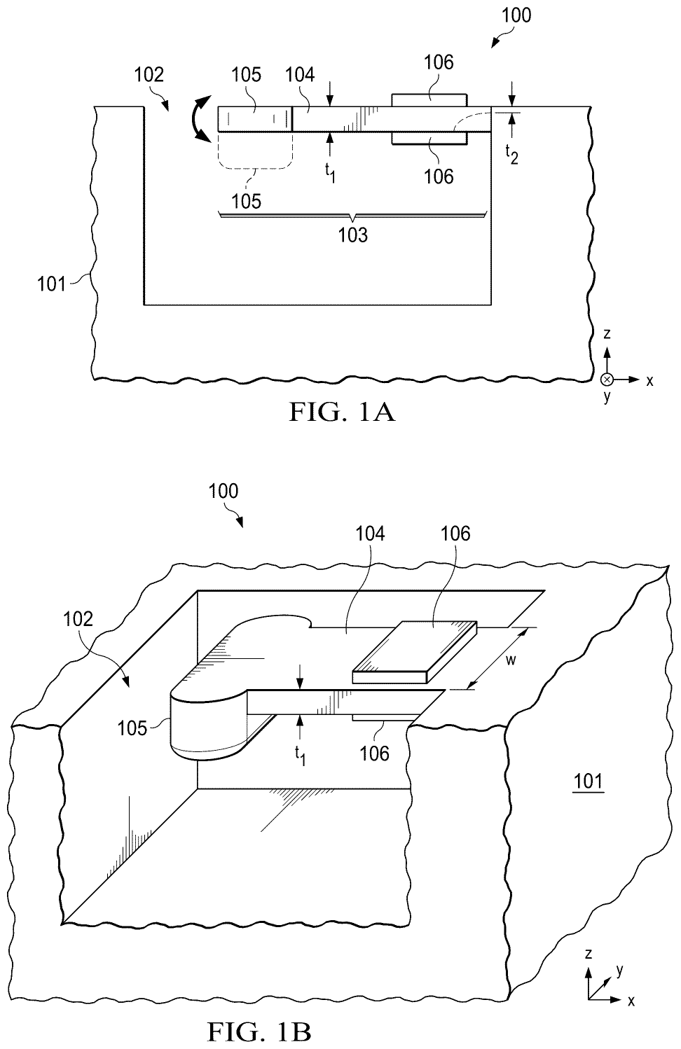

FIG. 1A is a schematic illustrating a side view of a motion sensor 100 with a swingable mass, in accordance with at least one example. FIG. 1B is a schematic illustrating a perspective view of the motion sensor of FIG. 1A, in accordance with at least one example. FIG. 1C is a schematic illustrating a top view of the motion sensor, in accordance with at least one example.

In at least one example, motion sensor 100 comprises a substrate 101 (e.g., a semiconductor bulk, such as a silicon bulk), a cavity 102 in substrate 101, and a cantilever 103. Cantilever 103 includes a beam 104 and a load mass 105, where a first end of beam 104 is connected to substrate 101 at an anchor point and a second end of beam 104 is connected to load mass 105. In at least one example, beam 104 and load mass 105 can have the same material as substrate 101 (e.g., silicon). In at least one example, beam 104 and mass 105 can include different materials. The first end is adjacent to the end of cavity 102. In at least one example, beam 104 has a thickness t₁ in a z-direction which is greater than a width w of beam 104 in a y-direction to allow load mass 105 to swing in a z-axis while restricting the rotation motion around the y-direction. As load mass 105 swings along the z-axis, beam 104 experiences a higher stress near its anchor point with substrate 101 which is one end of cavity 102. In at least one example, sensing elements 106 are placed on opposing surfaces of beam 104, or are part of beam 104, near the anchor point away from load mass 105 to sense the stress in beam 104 caused by swing in load mass 105.

In at least one example, the second end of beam 104 is made thinner with a thickness t₂ smaller than thickness t₁ and a width smaller than width w. A thinner beam portion near the second end of beam 104 increases sensitivity to sensing motion as it concentrates stress in the thinner beam portion. Sensing elements 106 may be placed on opposing sides of the thinner beam portion of beam 104 where concentration of stress is higher than other points along beam 104. The size of load mass 105 (and hence its mass) also impacts the sensitivity to sensing motion. For instance, a larger mass for load mass 105 increases sensitivity to sensing motion. In at least one example, the thickness t₁ of beam 104 is made larger than the width w of beam 104 to configure motion sensing in the y-direction with weak rotation motion around the z-direction. While various examples illustrate a rectangular cantilever, other shapes may be used that are configured to sense motion in a direction of interest and detect acceleration from mass inertia of load mass 105.

The unidirectional shock sensor of FIGS. 1A-C can be used for sensing a particular direction independent from other sensors to mitigate the issues of coupling from other sensors that sense motions in other directions. The independent nature of the unidirectional shock sensor of FIGS. 1A-C makes the processing simple and measurement very accurate. Processing may simplify because filters may not be used to filter coupled outputs from other sensors.

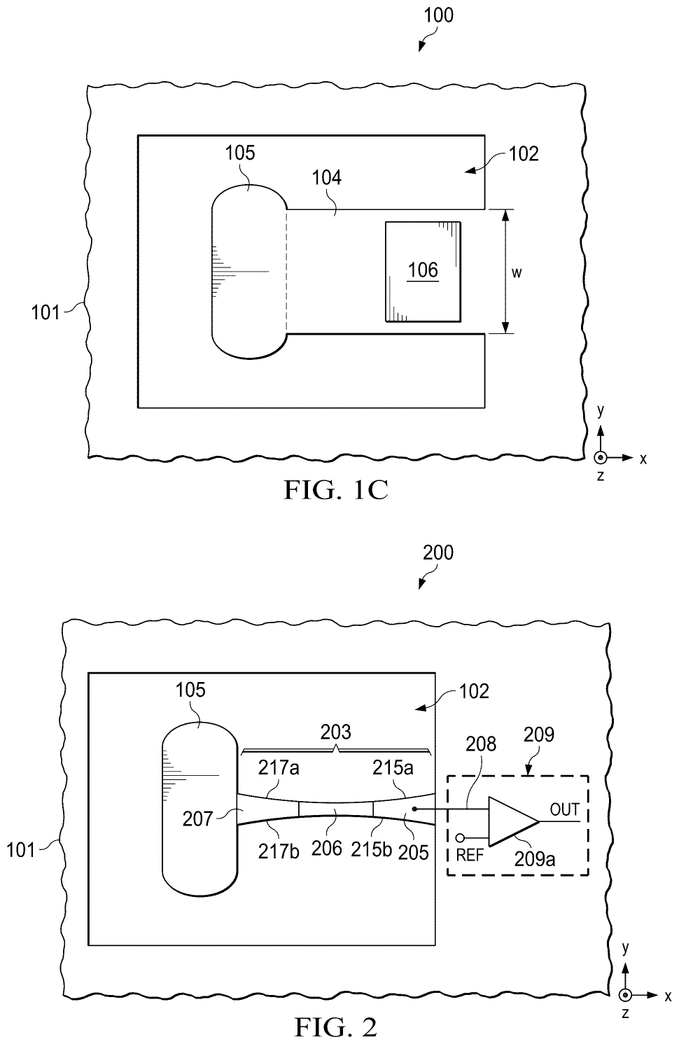

FIG. 2 is a schematic illustrating an apparatus 200 comprising a motion sensor with a processing circuit, in accordance with at least one example. In at least one example, cantilever 103 is made thinner in the middle and wider near the first and second ends of beam 104, with non-parallel opposing edges. Such a cantilever is illustrated by cantilever 203 with wider first and second ends 205 and 207 each with non-parallel opposing edges 215a and 217b and 217a and 217b, respectively, compared to the first and second ends of beam 104 of FIGS. 1A-C, respectively. The widths of first and second ends 205 and 207 decrease towards middle region 206 of cantilever 203, where middle region 206 is narrower than first and second ends 205 and 207. In at least one example, first end 205 is connected to substrate 101 at an end of cavity 102 while second end 207 is connected to load mass 105. Such arrangements can concentrate the stress at first and second ends 205 and 207, and the sensing elements are between the non-parallel edges to measure the concentrated stress to improve sensitivity, as to be described below. In at least one example, cantilever 203 is made shorter and wider to prevent gyration.

In at least one example, pair of sensing elements 106 are placed on opposing surfaces (e.g., upper surface and opposing lower surface) of cantilever 203 near first end 205 where stress is concentrated. Pair of sensing elements 106 are connected to a processing circuit 209 via a conductor 208. In at least one example, processing circuit 209 comprises a comparator 209a having a first input to receive conductor 208 and a second input to receive a reference Ref. The output out of comparator 209a indicates whether the voltage induced from the stress on cantilever 203 near first end 205 is above or below the reference Ref. Comparator 209a may be implemented using any semiconductor technology and transistors. In at least one example, processing circuit 209 is integrated on substrate 101. In at least one example, processing circuit 209 is an integrated circuit separate from substrate 101.

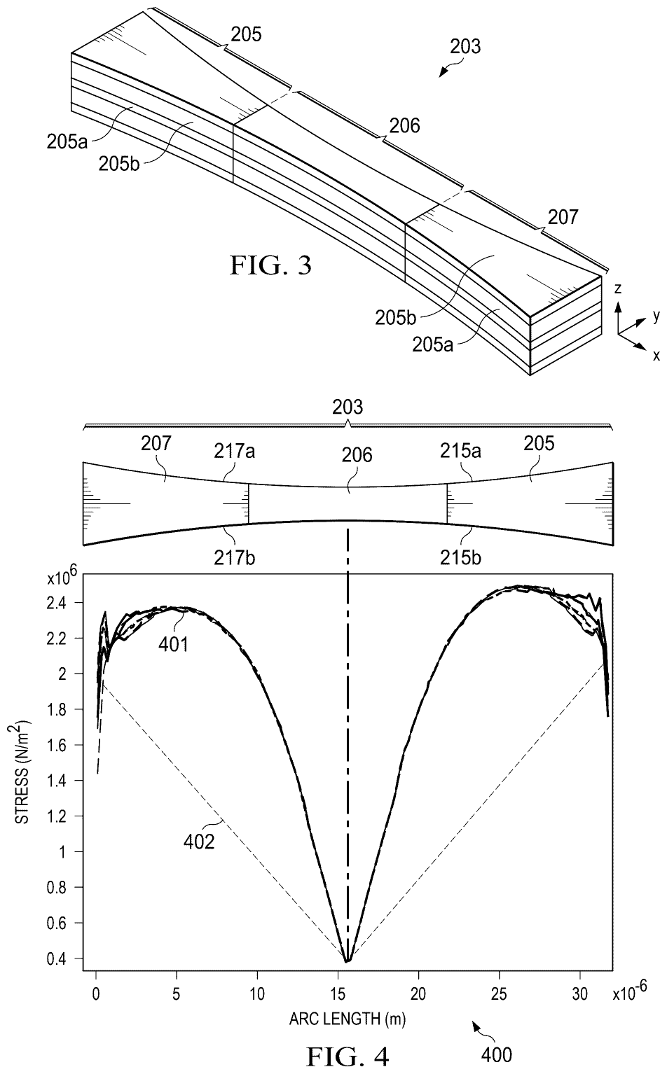

FIG. 3 is a schematic illustrating a perspective view of cantilever 203, in accordance with at least one example. As discussed herein, cantilever 203 is tapered and has first and second ends 205 and 207 with non-parallel opposing edges, and the widths of first end 205 and second end 207 decrease towards middle region 206 of cantilever 203, where middle region 206 is narrower than first and second ends 205 and 207. In at least one example, first and second ends 205 and 207 are bimorph with alternating layers of a first material 205a and a second material 205b which form the pair of sensing elements 106. In at least one example, first material 205a comprises molybdenum (Mo or “moly”, or any other suitable material for electrodes), and second material 205b comprises aluminum nitride (AlN) or any other suitable piezoelectric material, and each of first and second ends 205 and 207 includes a top electrode, a middle electrode, and a bottom electrode each of molybdenum and a piezoelectric material between the electrodes. In at least one example, middle region 206 comprises molybdenum or any other suitable material for electrodes. In at least one example, middle region 206 also comprises alternating layers of first material 205a and second material 205b. In at least one example, part of cantilever 203 where sensing elements 106 are placed comprises a biomorph structure while the rest of cantilever 203 comprises molybdenum or any other suitable electrode material. A bending of cantilever 203 (caused by a motion of mass 104, such as long the z-axis in FIG. 3) can create different stress in the piezoelectric material between the top and middle electrodes and between the middle and bottom electrodes of cantilever 203, which can induce different electric fields between the top and middle electrodes and between the middle and bottom electrodes. The magnitude and direction of the electric field difference can indicate the magnitude and direction of the motion of the motion sensor including cantilever 203.

In at least one example, cantilever 203 can be made of a semiconductor material same as substrate 101, and a pair of sensing elements 106, such as a pair of piezo resistors, can also be placed on opposing surface of cantilever 203 near first end 205 where stress is expected to concentrate. The resistance of a piezo resistor can change with the stress experienced by the piezo resistor, and the direction and magnitude of resistance difference between the pair of sensing elements 106 can also indicate the magnitude and direction of the motion of the motion sensor including cantilever 203.

In at least one example, to change direction of sensing motion, instead of stacking the alternating layers in the z-direction, the alternating layers can be stacked in the x-y direction and sensing elements can be placed on the side(s) (e.g., along z-direction) of cantilever 203.

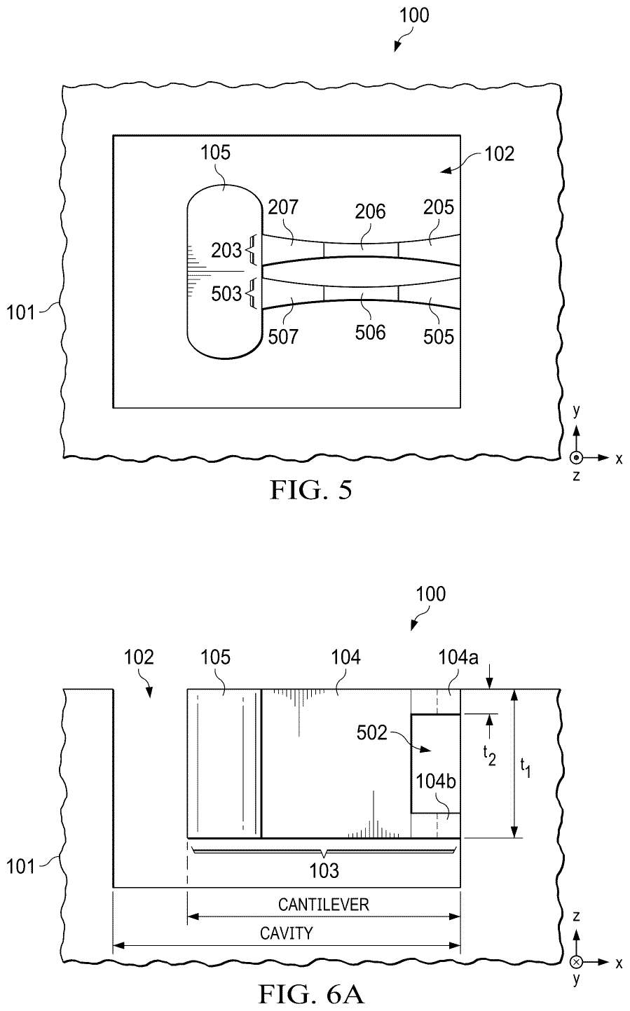

FIG. 4 is a plot 400 illustrating stress as function of position along the length of cantilever 203, in accordance with at least one example. Plot 400 shows stress along the length of the beam. Here, the abscissa contains position along the beam. Plot 400 shows that stress on cantilever 203 is highest in first and second ends 205 and 207 between non-parallel edges 215a/215b and 217a/217b, and lowest near the center of middle region 206. Stress initially increases along tapered first end 205 and then begins to lower towards middle region 206 as indicated by initial hump 401. The same symmetric stress behavior is seen from middle region 206 to second end 207. Initial hump 401 provides additional sensing margin or sensitivity to sense motion. A non-tapered cantilever 203 from first end 205 to second end 207 may not exhibit the initial hump (or exhibit a smaller bump) in the stress along the length of from first end 205 towards middle region 206 as indicated by linear stress behavior 402. In at least one example, beam 104 can be further shaped to enable a constant stress profile at the ends of beam 104 before the stress profile decreases near the middle of beam 104. In at least one example, sensing elements 106 can be positioned between the non-parallel edges of first end 205 and/or second end 207 to sense the elevated stress to improve sensitivity.

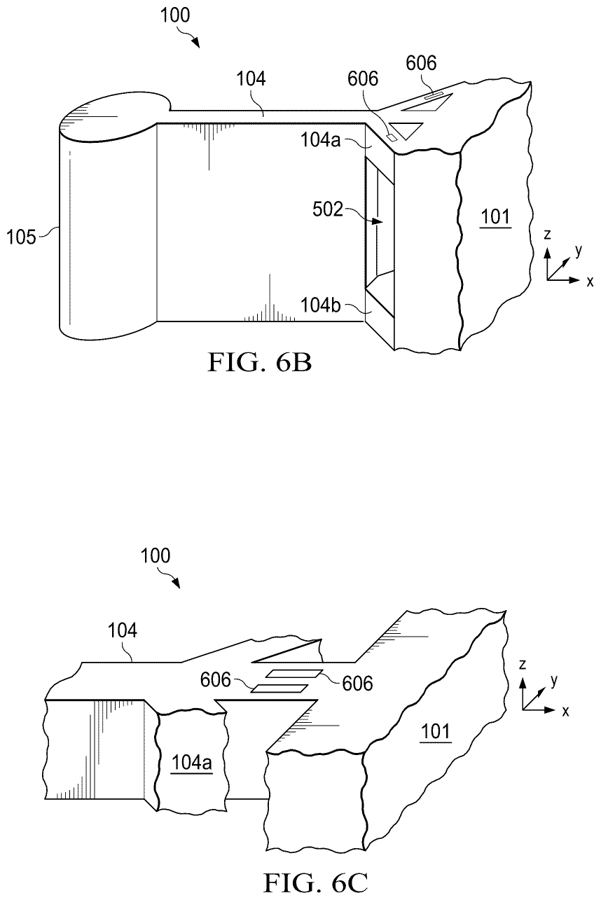

FIG. 5 is a schematic of a motion sensor with two parallel cantilevers 203 and 503, in accordance with at least one example. Like cantilever 203, cantilever 503 has wider first and second ends 505 and 507 and narrower middle region 506. First end 505 is connected to substrate 101 at the end of cavity 102 while second end 507 is connected to load mass 105. In at least one example, a pair of sensing elements are coupled to opposite surfaces of second end 507, and these sensing elements are further coupled to processing circuit 209. The parallel cantilevers 203 and 503 resist and reduce gyration of mass 105 around an axis perpendicular to the plane of cantilevers 203/503 (e.g., around the z-axis).

In at least one example, a portion of load mass extends from load mass 105 towards the end of cavity 102 and substrate 101 (e.g., near the first ends 205 and 505). This additional load mass 105 may not couple with substrate 101 and provides further stability from gyration when the motion sensor is rotated along the x-y plane. While two cantilevers are shown in parallel, more than two cantilevers may be arranged in parallel to prevent gyration while increasing (or at least maintaining) the sensitivity to motion.

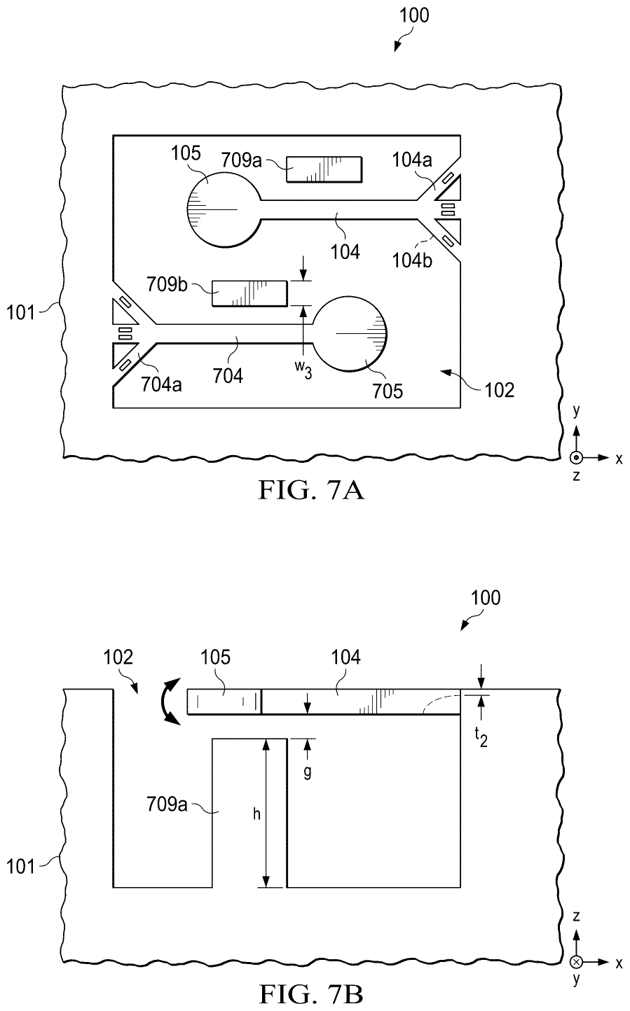

FIG. 6A is a schematic illustrating a side view of a motion sensor with a swingable mass and a hole region in the cantilever, in accordance with at least one example. FIG. 6B is a schematic illustrating a perspective view of the motion sensor of FIG. 6A with sensing elements on branches adjacent to the hole region, in accordance with at least one example. In at least one example, thickness t₁ of cantilever 103 (e.g., along the z-axis) is increased and area of cavity 102 under beam 104 is reduced as a result relative to motion sensor of FIG. 1A. A thicker cantilever 103 allows for sensing motion in the x-y plane where load mass 105 swings in the x and/or y directions. In at least one example, to increase sensitivity of detecting or sensing motion, a hole 502 is made at the end of cavity 102 and substrate 101 near the first end of beam 104. Hole 502 is made at a distance t₂ above bottom surface of beam 104 and below top surface of beam 104, to create side beams 104a and 104b each with a thickness of t₂. Such arrangements can weaken the coupling of beam 104 to substrate 101. This weak coupling results in a concentration of stress at side beams 104a and 104b of beam 104 above and below hole 502. Each of side beams 104a and 104b can include a semiconductor material same as substrate 101 (e.g., silicon), or a piezoelectric bimorph as shown in FIG. 3.

In at least one example, sensing elements 606 are placed on side beams 104a and 104b where stress sensitivity is the highest. In at least one example, the side beams can be tapered. In at least one example, the side beams can have bends at angles that provide high sensitivity to stress from movement of beam 104. In at least one example, side beams 104a and 104b of thickness t₂ are above and below hole 502, respectively, and are arranged at an angle from beam 104 that provides high stress sensitivity (e.g., side beams 104a and 104b are arranged at 45 degrees from beam 104). Hole 502 and side beams 104a and 104b prevent twisting or gyration of the motion sensor by increasing resonance frequency beyond a measurement range and by decreasing amplitude response in case of rotation excitation. In at least one example, sensing elements 606 are placed on side beams 104a and 104b where concentration of stress is present. In at least one example, each sensing element 606 includes a piezo resistor. Sensing elements 606 can be part of a resistive bridge network. The resistance difference between the pair of sensing elements 606 can be measured using the resistive bridge network, and the magnitude and direction of the resistance difference can indicate, respectively, the magnitude and direction of the motion of the motion sensor. In at least one example, sensing elements 606 are arranged at 45 degrees from beam 104 to form a resistive bridge network on side beams 104a and 104b.

In at least one example, beam 104 and side beams 104a and 104b comprise piezoelectric material. FIG. 6C is a schematic illustrating a partial perspective view of a portion of the motion sensor with sensing elements 606 on top of beam 104 of the motion sensor of FIG. 6A, in accordance with at least one example. Like FIG. 6B, sensing elements 606 are placed on beam 104 where concentration of stress is present.

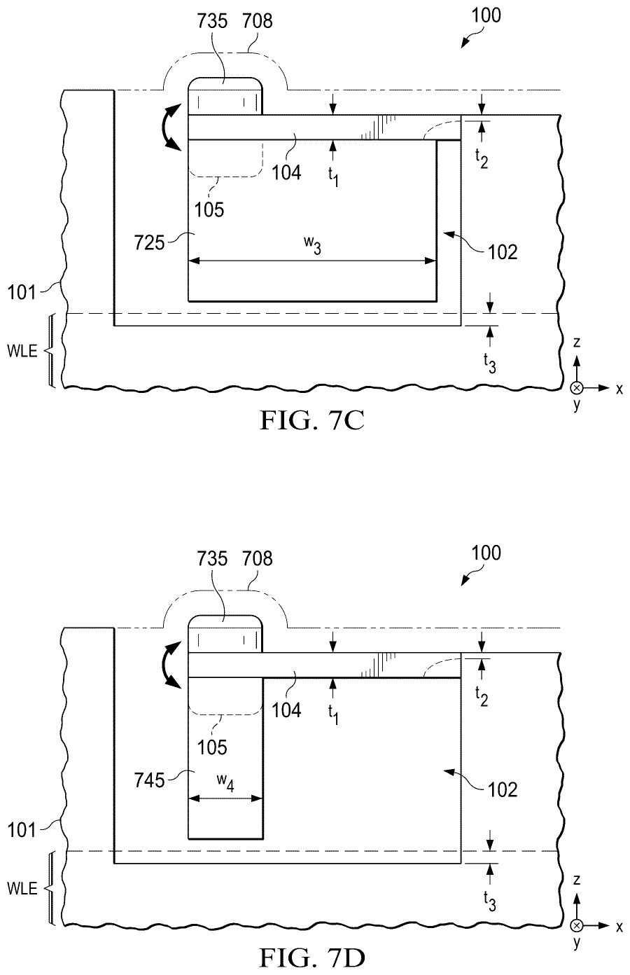

FIG. 7A is a schematic illustrating a top view of a pair of motion sensors with bumpers 709a and 709b configured to hinder swing above a threshold, in accordance with at least one example. Here, two inter-digitated cantilevers are shown including a first cantilever having beam 104 and side beam 104a as discussed with reference to FIG. 6A, and a second cantilever having beam 704, beam portion 704a, and load mass 705. The second cantilever is like the first cantilever and is connected to the opposite side of cavity 102 compared to the connection of the first cantilever. An over-shock to the motion sensor can cause excessive movement of the cantilevers and can break or damage the cantilevers. In at least one example, a first bumper 709a of width w₃ is formed near the first cantilever, while a second bumper 709b of width w₃ is formed near the second cantilever. First and second bumpers 709a and 709b restrict motion of the first and second cantilevers, respectively. In this example, the first and second cantilevers swing in the y-direction and first and second bumpers 709a and 709b are formed of substrate 101 (e.g., silicon) that limit the swing in the y-direction. In at least one example, first and second bumpers 709a and 709b have width w₃ which is large enough to restrict the swing of the first and second cantilevers in the y-direction. In at least one example, first and second bumpers 709a and 709b are pillars of substrate extending up within cavity 102 to a level of an upper surface of the first and second cantilevers. In at least one example, the first and second cantilevers of FIG. 7A are formed of piezoelectric material (e.g., a bimorph structure). In at least one example, the first and second cantilevers of FIG. 7A are formed of resistive material.

FIG. 7B is a schematic illustrating a side view of one of the motion sensors configured to swing in the z-direction, in accordance with at least one example. In at least one example, cavity 102 is etched in substrate 101 forming small pillars of substrate of width w₃ and a height h that extends from a bottom surface of cavity 102 to below bottom surfaces of beams 104 and 704 leaving a cavity gap g. As such, oscillating motion of load mass 105 is stopped by bumper 709a. In at least one example, a glass cover or similar barrier is used above the motion sensor to limit up-motion.

In at least one example, cantilevers themselves are used as bumpers for adjacent cantilevers. For example, instances of second cantilevers may be used as bumpers for instances of first cantilevers. In one such example, the first cantilevers are sensing motion while the second cantilevers are dummy cantilevers that are used as bumpers for adjacent cantilevers.

FIG. 7C is a schematic illustrating a side view of with mass added under the cantilever and above the load mass, in accordance with at least one example. In at least one example, oscillations in the cantilever are reduced by adding mass 705 on load mass 105. In at least one example, to allow cantilever to move in the y-direction, an encapsulation 708 is formed above mass 705. Cavity 102 between the top surfaces of mass 705 and encapsulation 708 provides an area for load mass 105 to move up during sensing. Encapsulation 708 behaves as a bumper to limit upward motion (in the y-direction) for the cantilever. In at least one example, encapsulation 708 is part of an encapsulation wafer which is configured on top of the cantilever while leaving a gap between the cantilever and the encapsulation wafer to allow for cantilever motion. In at least one example, substrate 101 is etched by thickness t₃ to give freedom of movement to mass 725. As discussed herein, substrate 101 can include wafer-level encapsulation (WLE) material which protects the sensor from external environmental elements. In at least one example, oscillations in the cantilever are reduced by adding mass 725 under beam 104 and load mass 105, where w₃ is the width of mass 725. In at least one example, mass 725 comprises silicon.

FIG. 7D is a schematic illustrating a side view of an individual motion sensor with mass added under and above the load mass, in accordance with at least one example. In at least one example, the volume and size of mass 725 of FIG. 7C is reduced as mass 745 to be under load mass 105. Mass 745 has a width w₄ which is smaller than width w₃ and is large enough to reduce oscillation in the cantilever.

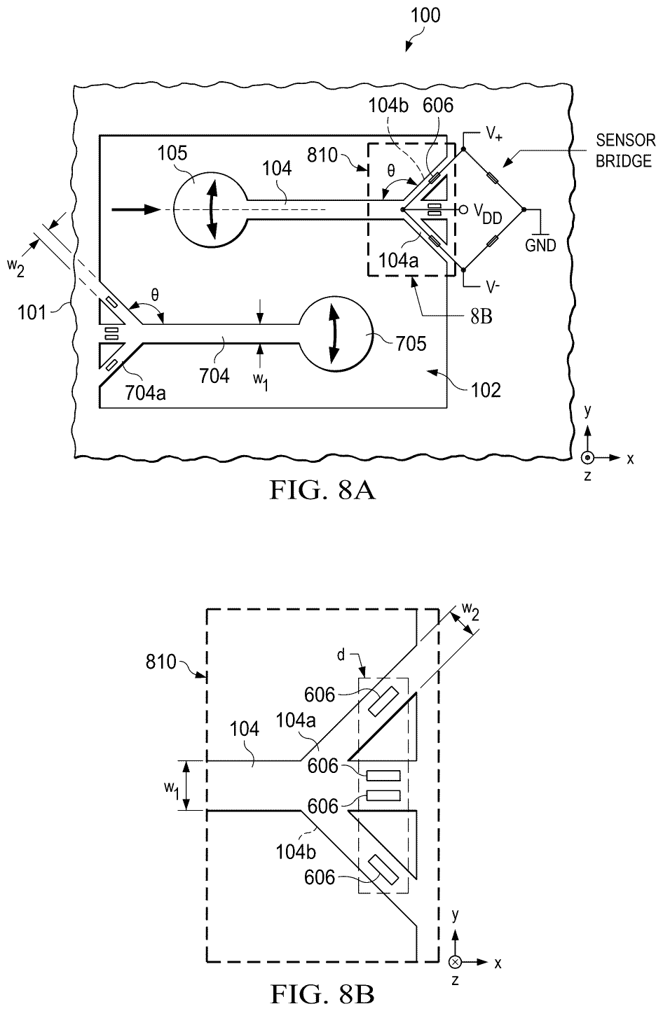

FIG. 8A is a schematic illustrating a top view of a pair of motion sensors with resistive sensing bridges, in accordance with at least one example. FIG. 8B is a schematic illustrating a portion of one of the sensing bridges, in accordance with at least one example. In this example, the thickness t₁ and width w₁ of beam 104 is made such that load mass 105 swings in the y-direction. In at least one example, sensing elements 606 are placed on side beams 104a and 104b forming a resistive bridge 810 that senses stress on side beams 104a and 104b caused by motion of load mass 105. Sensing elements 606 may also be positioned on the first end of beam 104 within resistive bridge 810 and near the end of cavity 102. Stress is concentrated on the narrow beam portions within resistive bridge 810, and so the narrow beam portions are used for sensing elements 606. In at least one example, the same structure for FIGS. 8A-B can be configured for piezoelectric sensing. In one such example, sensing elements 606 sense stress/strain caused by piezoelectric based bean 104.

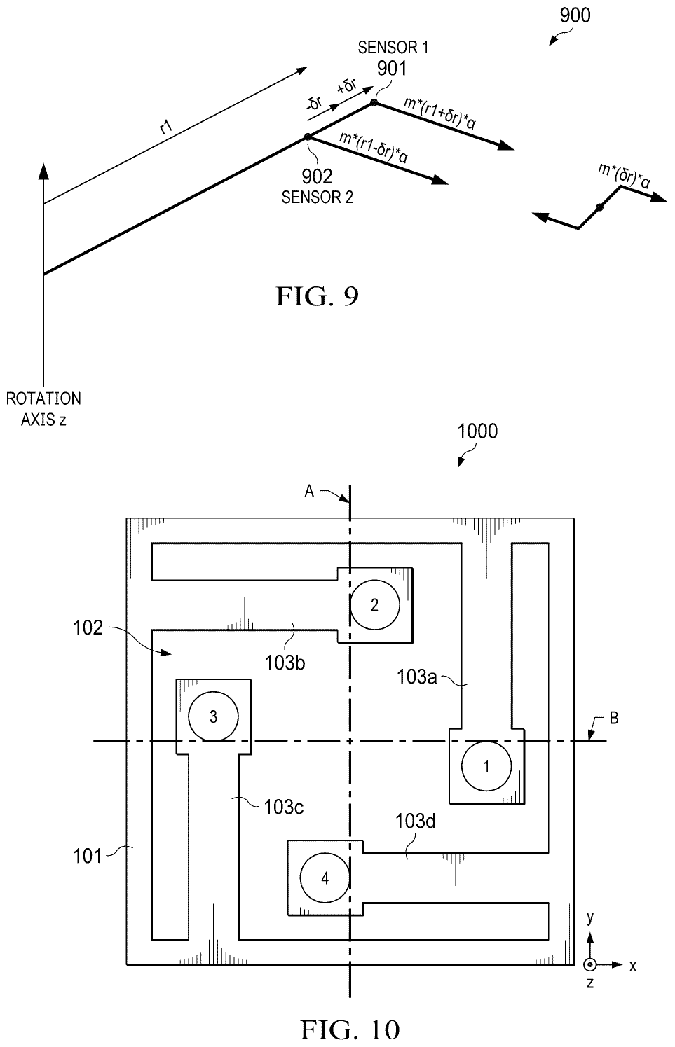

FIG. 9 is a schematic of a 3D plot 900 illustrating gyration measurement of motion sensor of FIG. 8A around a z-axis away from a center of the pair of motion sensors, in accordance with at least one example. Gyration is rapid movement in a circle and can be another application independent of vibration and shock. Measurement of gyration can be used in navigation (e.g., in airplanes and ships for keeping track of their direction).

Gyration along the z-direction can be measured at the center of motion sensor of FIG. 8A. Gyration along the z-direction at the center of motion sensor of FIG. 8A introduces centripetal forces on the first cantilever motion sensor (sensor 1) that comprises beam 104 and load mass 105, and the second cantilever motion sensor (sensor 2) that comprises beam 704 and load mass 705. The centripetal forces cause the first cantilever motion sensor and the second cantilever motion sensor to move in opposite directions. For instance, the first cantilever motion sensor moves up and the second cantilever motion sensor moves down. The separation of the first cantilever motion sensor and the second cantilever motion sensor can be measured with a resistive bridge, and this measurement that represents difference in signal strength indicates gyration.

Gyration along the z-direction can also be measured far away from the center of motion sensor of FIG. 8A. In this case, the centripetal force points in the same direction for both the first cantilever based motion sensor 901 and the second cantilever based motion sensor 902 but with different strength due to different radius. The difference between the two strengths in the centripetal forces is the gyration.

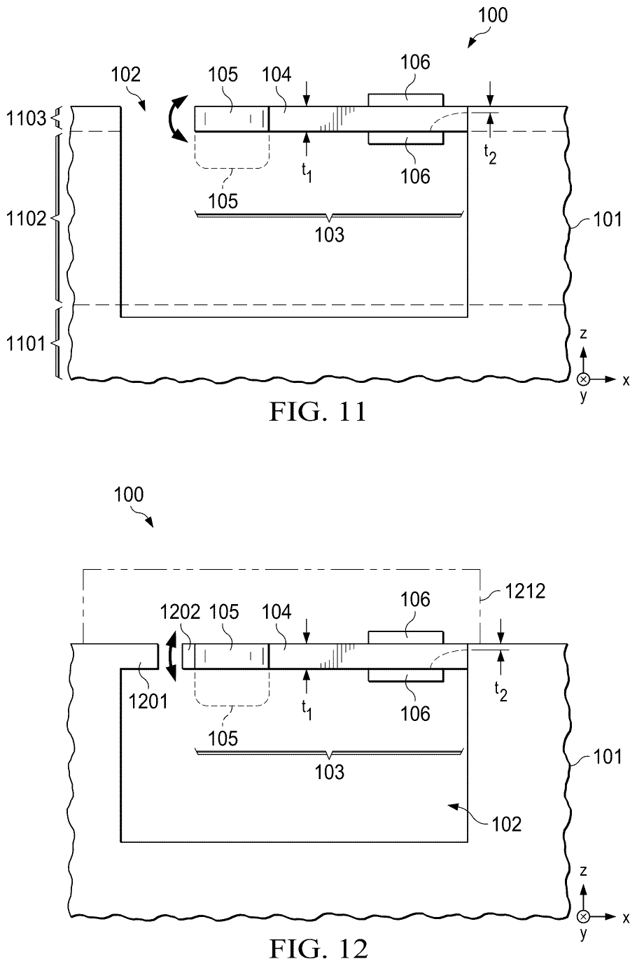

FIG. 10 is a schematic of a motion sensor 1000 with four orthogonally placed cantilevers 103a, 103b, 103d, and 103c with swingable masses, in accordance with at least one example. When cantilevers with swingable masses are not orthogonal to one another, four individual resonant frequencies are observed due to coupling through the center of the cantilevers. In at least one example, with orthogonally placed cantilevers 103a, 103b, 103d, and 103c with swingable masses, the cantilevers are independent levers having independent resonant frequencies. Shock or motion is detected from amplitude, phase, and frequency. Here, the first end of each cantilever terminates into the substrate. In at least one example, the width of the beams of each cantilever is made wide enough to reduce twist.

Motion sensor 1000 shows rotational symmetry around A and B axes where each quadrant is a copy of another quadrant rotated by 90 degrees. Cantilevers of motion sensor 1000 are configured such that cantilevers 103a and 103b are a mirror image of cantilevers 103c and 103d. Here, the left half of the layout of cantilevers is a copy of the right half, mirrored around the y-axis (A-axis), and the top half of the layout of cantilevers is a copy of the bottom half, mirrored around the x-axis (B-axis).

Process variations may be cancelled or averaged out with symmetrical layout of cantilevers such as the one in motion sensor 1000. Consider an example where an anchor point of a beam favors a motion towards its respective left side e.g., the beam of cantilever 103c favors direction “left,” and the beam of cantilever 103a favors direction “right.” If an acceleration is applied in the x-direction (along the B-axis) and motion is measured for cantilevers 103a and 103c, an average signal is measured because signal from positive and negative acceleration (+x, and −x) from the two cantilevers will be symmetric in magnitude.

Depending on the aspect ratios of heights and widths of the beams of cantilevers 103a, 103b, 103c, and 103d, in-plane or out of plane motions are achieved. For instance, very thin and wide beams produce out of plane motion, and thick and narrow beams produce in-plane motion. Cantilevers 103a, 103b, 103c, and 103d can be piezoelectric, piezoresistive, capacitive or a combination of them oriented as shown to average out asymmetries and mismatches, in accordance with at least one example.

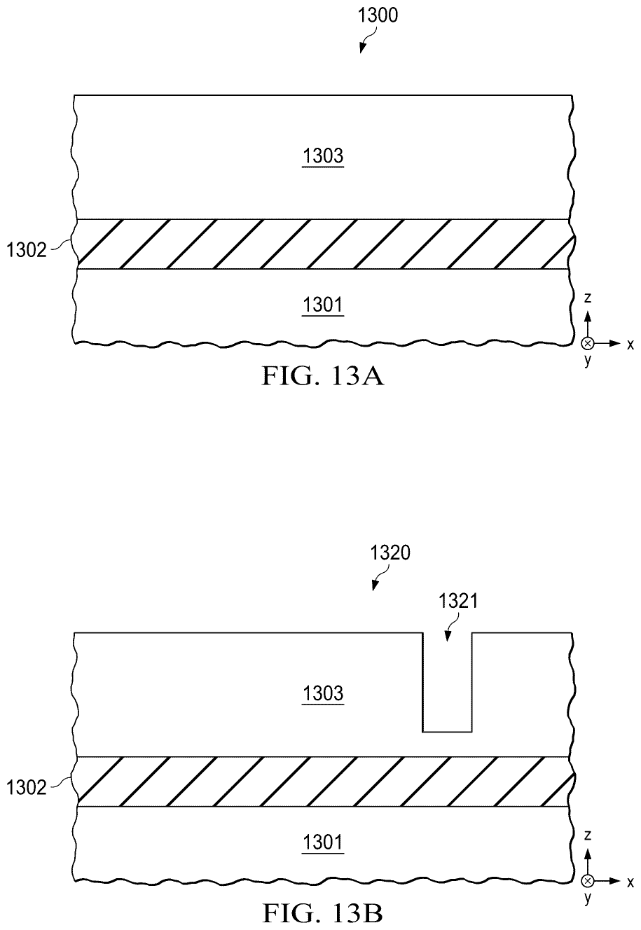

FIG. 11 is a schematic illustrating process regions for the motion sensor of FIG. 1A, in accordance with at least one example. In at least one example, substrate 101 (e.g., silicon bulk) is a wafer-level encapsulation (WLE) material 1101. WLE material 1101 provides protection to devices from environmental factors such as moisture, dust, and mechanical stress. WLE material 1101 can also work as a limitation to movement. For example, load mass 105 may crash into WLE material 1101 if acceleration/force is too large, yet WLE material 1101 can protect load mass 105 from being damaged from the crash.

In at least one example, cavity 102 under cantilever 103 is formed by processes used to make a micro-electro-mechanical system (MEMS) 1102. Cavity 102 is formed by etching MEMS 1102 from the bottom followed by attaching WLE material 1101 to the bottom of MEMS 1102.

In at least one example, cantilever 103 is partially formed by etching processes of inter-layer dielectric (ILD) 1103. In at least one example, beam 104 is formed by backside etching of MEMS 1102 with plasma etching via a chemical component which stops at the bottom surface of beam 104 from etch selectivity. Etching may stop at the bottom surface of beam 104 either because beam 104 is made of a different material or because there is a thin additional different-material-layer right below beam 104. In at least one example, cantilever 103 is shaped to form beam 104 and load mass 105 using pn-junction electrochemical etch stop. In at least one example, reverse biased pn-junction etch stop technique is used for shaping beam 104 and load mass 105. In the reverse biased pn-junction etch stop technique, tetramethylammonium hydroxide (TMAH) etching stops in a depletion region of a pn-junction due to a change in electrochemical potential.

Segmenting the process of forming the motion sensor into process regions indicated by WLE material 1101, MEMS 1102, and ILD 1103 enables manufacturability. MEMS 1102 is processed separately from WLE material 1101. ILD 1103 is on top of MEMS 1102 (e.g., metal levels such as layers forming a sandwich of aluminum nitride and molybdenum). After processing MEMS 1102 to form cantilever 103, the process regions are bonded, glued, or attached together. In at least one example, a WLE wafer is placed on top of cantilever 103 with a shallow cavity around beam 104 so that beam 104 can move upwards as discussed with reference to FIGS. 7C-D.

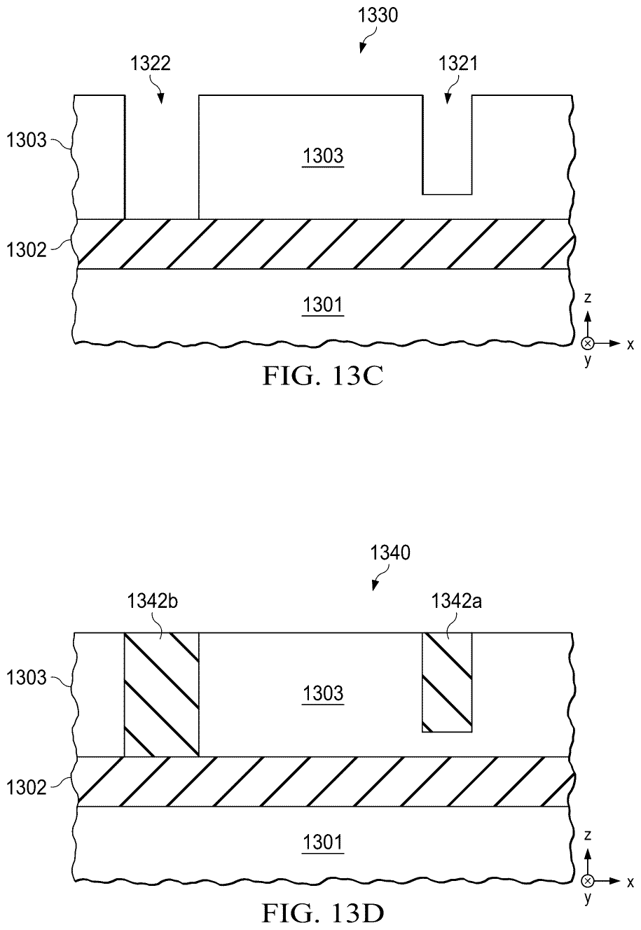

FIG. 12 is a schematic illustrating a motion sensor with a protrusion from substrate 101 to adjust a cavity gap between a swingable mass and the silicon protrusion to control oscillation of a cantilever, in accordance with at least one example. In some cases, cantilever 103 may oscillate upon receiving a shock or motion. In this example, cantilever 103 may oscillate in the z-direction and this oscillation may continue well after the shock or motion has ended. In at least one example, a substrate protrusion 1201 (e.g., silicon protrusion) is formed between load mass 105 and an end of cavity 102. Substrate protrusion 1201 reduces a cavity portion between load mass 105 and the edge of end of cavity 102, and this controls the amount friction from air experienced by load mass 105 as it swings. In at least one example, cantilever 103 is extended by cantilever portion 1202 after load mass 104. Cantilever portion 1202 and substrate protrusion 1201 may have similar surface areas facing each other and leave a narrower opening between them for air friction. By increasing the friction using air as a dampening medium, the oscillations may be reduced. In at least one example, friction can be controlled by controlling air pressure in the opening between substrate protrusion 1201 and load mass 105. In at least one example, friction can be controlled by controlling air pressure in the opening between substrate protrusion 1201 and cantilever portion 1202.

In at least one example, oscillation may also be reduced by adding a mass body 1212 (e.g., plastic such as parylene) over cantilever 103. In at least one example, mass body 1212 dampens oscillation by absorbing energy from beam 104.

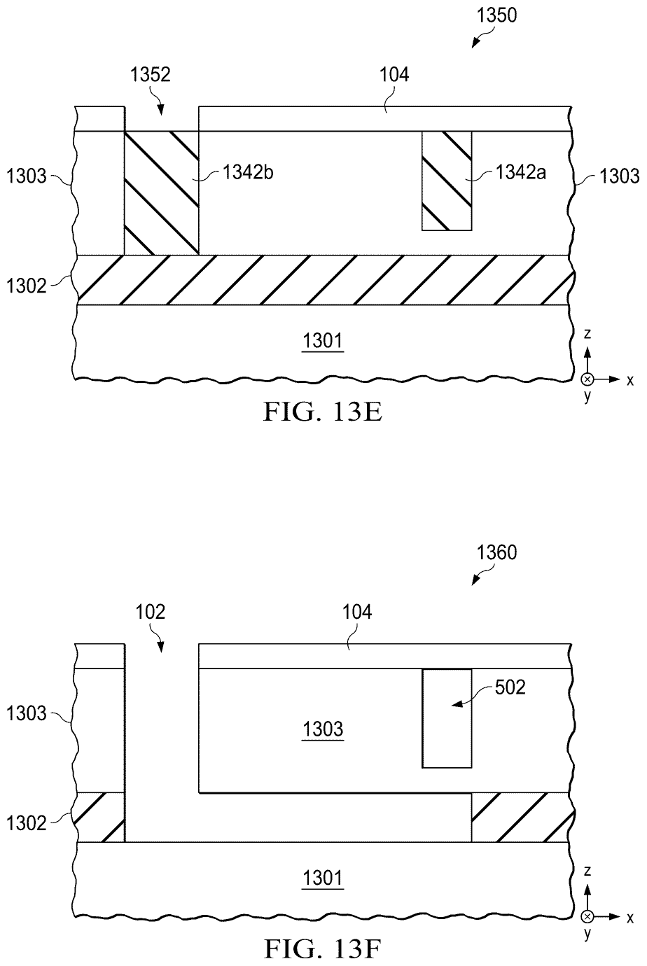

FIGS. 13A-F are schematics illustrating process flows for forming a unidirectional motion sensor, in accordance with some examples. In at least one example, a piezoelectric layer stack is deposited on silicon. For instance, a full layer of AlN seed is deposited and on top of this the lowest electrode layer (molybdenum) is deposited and structured. Then a blanket layer of AlN is deposited followed by deposition and structuring of a middle molybdenum layer. Thereafter, a blanket AlN layer is formed and then a top molybdenum layer is deposited and structured. In at least one example, a plasma etch is performed from the top to structure the beams and over-shock stoppers discussed below. In at least one example, plasma etch is also performed from the bottom to separate the load mass from the substrate bulk so that the load mass hangs on the beams.

Cross-section 1300 illustrates a stack of layers comprising a first substrate 1301 (e.g., silicon bulk), an oxide layer 1302 (e.g., interlayer dielectric such as a SiO₂) on first substrate 1301, and a second substrate 1303 (e.g., silicon) on oxide layer 1302. This stack of layers is then processed to form a unidirectional motion or shock sensor. Cross-section 1320 illustrates etching of second substrate 1303 to create a hole 1321 (e.g., for making hole 502). Cross-section 1330 illustrates etching of second substrate 1303 to create a hole 1322 up to oxide layer 1302. Hole 1322 is used to form cavity 102. Cross-section 1340 illustrates deposition of holes 1321 and 1322 with silicon oxides 1342a and 1342b, respectively. Cross-section 1350 illustrates deposition of poly silicon to form beam 104 over second substrate 1303 followed by etching of poly silicon over region 1352 above oxide 1342a in hole 1322. Cross-section 1360 illustrates release of oxide of oxide layer 1302, and oxides 1342a and 1342b to form cavity 102 and hole 502.

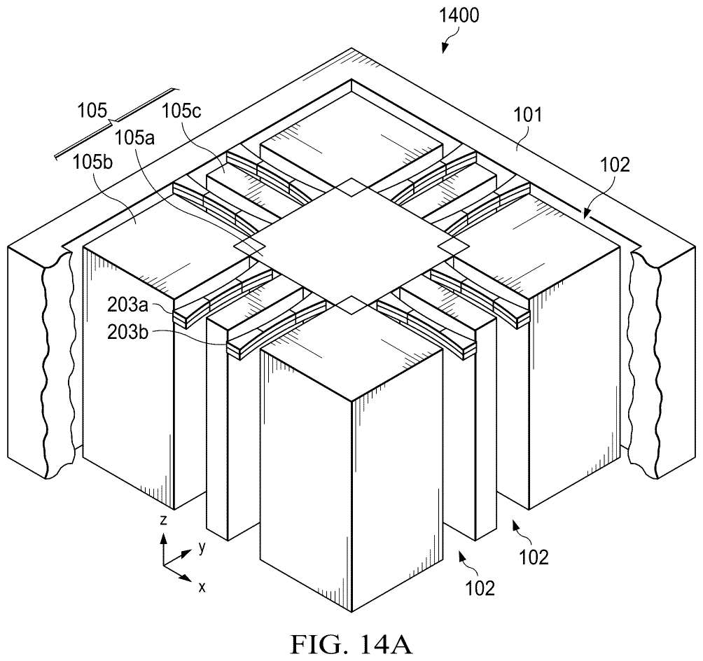

The concept of unidirectional motion or shock sensors can be extended to a multi-directional motion sensor, which includes a swing mass coupled to a substrate via beams that extend along multiple axes to detect motion along different directions. FIG. 14A is a schematic illustrating a perspective view of a multi-directional motion sensor 1400 that can sense motion along different directions, in accordance with at least one example. FIG. 14B is a schematic illustrating a top view of motion sensor 1400, in accordance with at least one example. In at least one example, motion sensor 1400 comprises substrate 101 (e.g., silicon bulk), cavity 102, load mass 105 having a center portion 105a and extension portions extending from the sides and corners of center portion 105a, such as extension portion 105b (extending from a corner of center portion 105a) and 105c (extending from a side of center portion 105a), and cantilevers 203 (e.g., cantilevers 203a and 203b). Load mass 105 is a moveable mass, which is coupled to substrate 101 via cantilevers 203. In at least one example, cantilevers 203 have a first end 205 connected to substrate 101 and a second end 207 connected to load mass portion 105a. For instance, cantilever 203a is connected to substrate 101 and central load mass portion 105a. In at least one example, cantilevers 203 are arranged along at least four directions (e.g., +y, −y, +x, and −x directions) to detect motion or shock in the three axes. In at least one example, load mass portions 105b are arranged along the four corners within a boundary of substrate 101. In at least one example, pairs of cantilevers (e.g., cantilevers 203a and 203b) are arranged in one direction (e.g., −x direction). Here, four such pairs are shown. In at least one example, load mass portion 105c extends laterally between the two cantilevers of the pair. Load mass portion 105c mitigates gyration in cantilevers 203a and 203b because it separates cantilevers 203a and 203b. Load mass portions 105a, 105b, and 105c are all connected to form a uniform larger load mass. Such arrangements can provide a larger load mass to improve sensitivity for detection of shock or motion, while maintaining the overall footprint of motion sensor 1400. In at least one example, one or more cantilevers (not shown) may be arranged along the z-direction (e.g., +z and/or −z directions).

Motion sensor 1400 of FIGS. 14A-B and subsequent figures can be configured as a voice accelerometer. A voice accelerometer can sense the direction and speed of acceleration of the accelerometer caused by sound vibration and convert the sensed acceleration into electrical signals representing the sound vibration. In at least one example, the voice accelerometer can be attached to a body part of a person that can vibrate as the person speaks, and the voice accelerometer, as well as the load mass, can move due to the vibration. The voice accelerometer can sense the motion of the load mass and convert the motion into electrical signals representing the voice/speech of the person, while being insensitive (or less sensitive) to sound transmitted through air. As such, the voice accelerometer can detect voice from the speaker while removing (or at least attenuating) external environmental noise. The voice accelerometer can include stiffer and shorter beams, which allow the resonant frequency of the accelerometer to be outside an audible frequency range. Such arrangements allow for a flat response in an audio range of interest (e.g., resonance frequency is at 7 kHz and the application is interested in an audio range up to 4 kHz) to facilitate the sensing and conversion of human voice into electrical signals. For example, in FIG. 14 and in subsequent figures, each beam can have a length of less than half, or a quarter, of the overall length of mass 105 (including center portion 105a and corner portions 105b), which allow the resonant frequency of the accelerometer to be outside an audible frequency range. In at least one example, resonance frequency of the accelerometer increases by shortening the beam. In at least one example, resonance frequency of the accelerometer increases by decreasing the mass, increasing the width of the beam, and/or by increasing the thickness of the beam.

In at least one example, a pair of a pair of sensing elements are on individual cantilevers on their beam near load mass portion 105a and away from the side of the cavity adjacent to substrate 101. In at least one example, a processing circuit is coupled to the pair of sensing elements and configured to receive a signal from the pair of sensing elements, the signal representing a measurement of a motion of the voice accelerometer. In at least one example, the processing circuit is configured to provide an audio signal based on the signal.

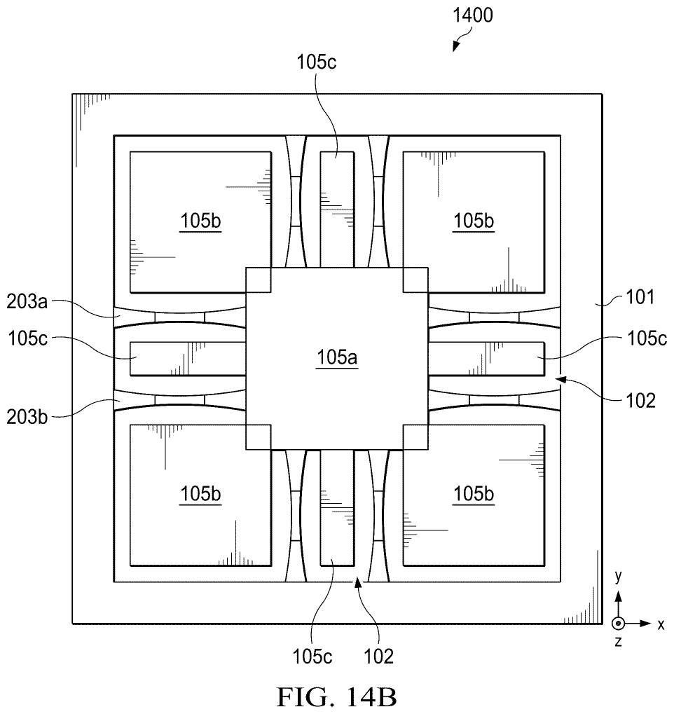

FIG. 15 is a schematic illustrating a perspective view of a motion sensor 1400 with a larger center mass and shorter and wider sensor beams (e.g., compared with FIGS. 14A-B), in accordance with at least one example. Here, load mass portion 105a is larger than load pass portion 105a of FIGS. 14A-B, load mass portion 105b is smaller than load mass portion 105b of FIGS. 14A-B, and cantilevers 203 (e.g., cantilevers 203a and 203b) are shorter and wider than cantilevers 203 of FIGS. 14A-B. Such a configuration may provide higher sensitivity to motion sensing because the center load mass is larger and stress on cantilevers 203 is more concentrated near second end 207 that abuts load mass portion 105a. In at least one example, stiffer and shorter sensor beams allow resonant frequency of the cantilevers to be outside an audible frequency range, which allows a flat response in an audio range in a case where motion 1400 is configured as a voice accelerometer. Tapered cantilevers as shown can increase signal-to-noise ratio (SNR).

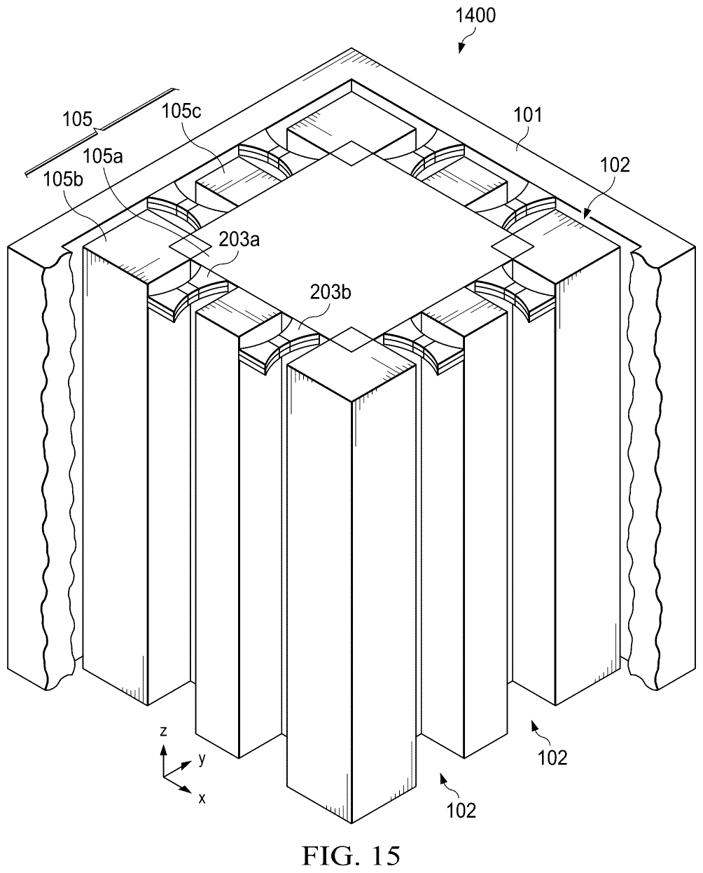

FIG. 16 is a schematic illustrating a top view of a motion sensor 1600 with over-shock stoppers, in accordance with at least one example. Motion sensor 1600 can be example of motion sensor 1400. When cantilevers 203 experience large swing motions due to excessive motion of motion sensor 1600 caused by, for example, excessive sound vibration, dropping of motion sensor 1600 onto the ground, etc., cantilevers 203 may be damaged. To avoid damage to cantilevers 203, over-shock stoppers 1621 are distributed in areas 1620 along corners edges of load pass portions 105b. In at least one example, over-shock stoppers 1621 include a first set of cantilevers that are anchored to substrate 101 and a second set of cantilevers that are anchored to corner load mass portions 105b. The first set of cantilevers are blocked from swinging beyond a threshold by corner load mass portions 105b. The second set of cantilevers are blocked from swinging beyond a threshold by substrate 101.

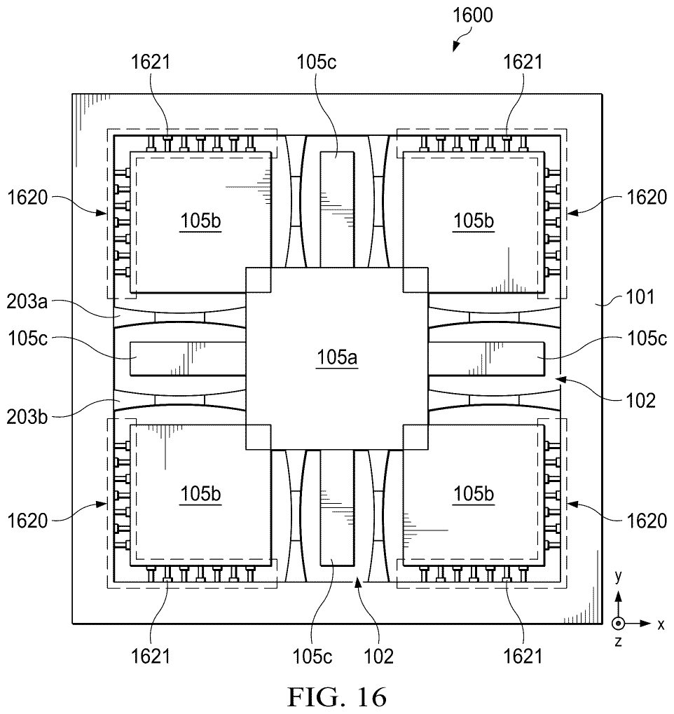

FIGS. 17A-C are schematics illustrating cross-sectional views of over-shock stoppers and their placement in the voice accelerometer, in accordance with at least one example. Here, over-shock stoppers 1621 are expanded to show an individual cantilever 1725 of the first set of cantilevers and an individual cantilever 1735 of the second set of cantilevers. In at least one example, individual cantilevers from the first and second set of cantilevers are interdigitated (e.g., repeated in alternating arrangement).

In at least one example, a grove 1726 of height h₁ is etched in substrate 101 to make a small cavity for individual cantilever 1725 to swing. In at least one example, individual cantilever 1725 of the first set of cantilevers includes a bimorph piezoelectric beam, which is anchored at one end to load mass portion 105b while the other end is free to swing in the z direction (in this example) within distance h₁. In at least one example, a mass portion 1728 on substrate 101 faces the other end of cantilever 1727 that is unconnected such that a small opening separates mass portion 1728 and cantilever 1727. In at least one example, when load mass portion 105b lowers or drops in the z-direction (e.g., downward direction 1729), cantilever 1727 also drops by distance h₁ and then halts the downward motion because substrate 101 no longer allows cantilever 1725 to move down. As such, the cantilevers of motion sensor 1600 can no longer swing down beyond distance h₁. This prevents breaking of cantilevers 203 in the downward movement of load mass 105.

In at least one example, a grove 1736 of height h₁ is etched in load mass portion 105b to make a small cavity for individual cantilever 1735 to swing. In at least one example, individual cantilever 1735 of the second set of cantilevers includes a bimorph piezoelectric beam, which is anchored at one end to substrate 101 while the other end is free to swing in the z-direction (in this example) within distance h₁. In at least one example, a mass portion 1738 on load mass portion 105b faces the other end of cantilever 1737 that is unconnected such that a small opening separates the mass portion 1738 and cantilever 1737. In at least one example, when load mass portion 105b rises or moves up in the z-direction (e.g., upward direction 1739), cantilever 1737 also drops by distance h₁, and then halts the upward motion because substrate 101 no longer allows cantilever 1735 to move up. As such, the cantilevers of motion sensor 1600 can no longer swing up beyond distance h₁. This prevents breaking of cantilevers 203 in the upward movement of load mass 105.

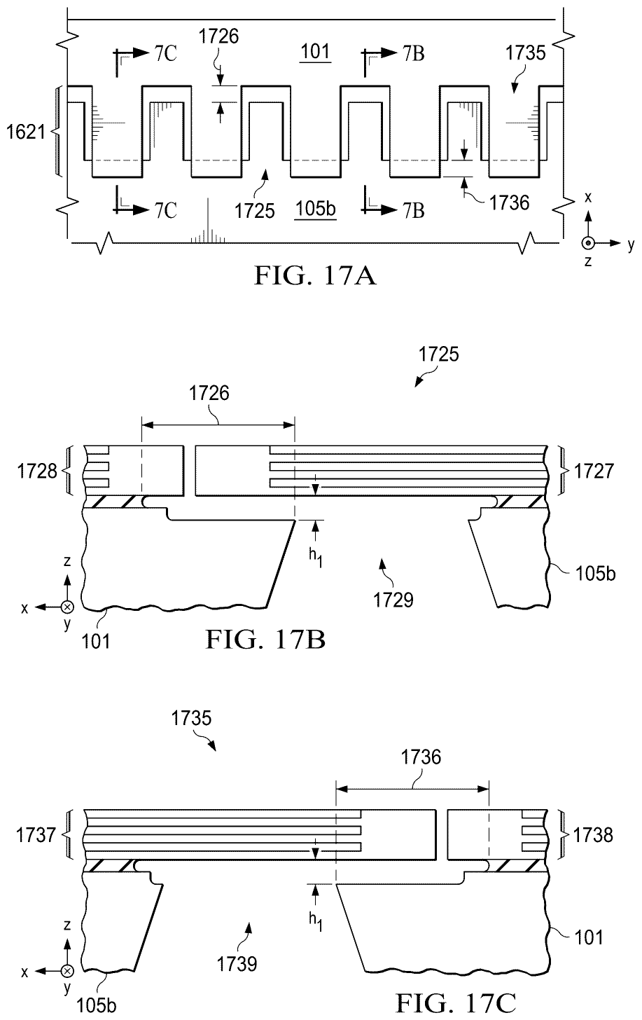

FIG. 18 is a plot 1800 illustrating an audible range of a motion sensor (e.g., motion sensor 1400/1600) configured as a voice accelerometer, in accordance with at least one example. Cantilevers 203 have a resonant frequency. Cantilevers 203 are configured to swing and capture sound within an audible range of, for example, 100 Hz to 4 KHz, which is less than the resonant frequency. In at least one example, making load mass 105 larger and cantilevers 203 smaller and wider allow cantilevers 203 to swing within the audible range of 100 Hz to 4 KHz. Stiffer and shorter beams allow resonant frequency to be outside the audible frequency range, which allows for a flat gain response in the audio range of interest (e.g., region left of the resonant frequency).

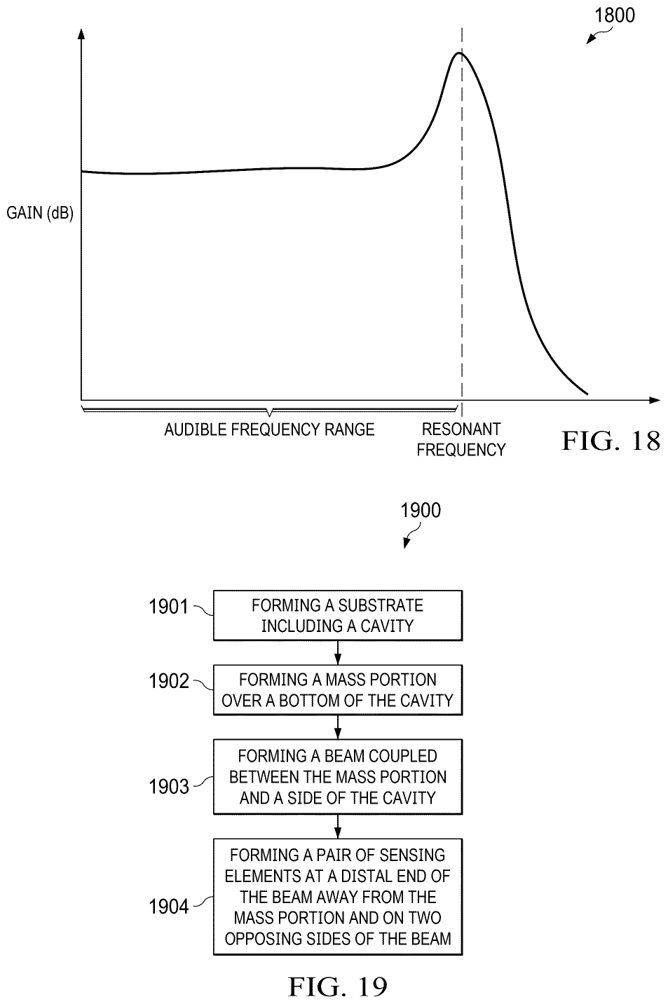

FIG. 19 is a flowchart 1900 of a method of forming a motion sensor, in accordance with at least one example. In at least one example, the process of forming the motion sensor starts with a full wafer and a process of etching from top and bottom to form the cantilevers, cavities, and bumpers. At block 1901, substrate 101 is formed and cavity 102 is etched into substrate 101 as discussed with reference to FIGS. 13A-F. At block 1902, load mass 105 is formed over the bottom of cavity 102. At block 1903, beam 104 is formed and coupled between load mass 105 and a side of cavity 102 which is adjacent to substrate 101. At block 1904, pair of sensing elements 106 are formed at a distal end of beam 104 away from load mass 105 and on two opposing sides of beam 104.

Following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementation without changing the scope of disclosure.
Example 1 is an apparatus comprising a motion sensor including: a semiconductor substrate including a cavity; a mass portion over a bottom of the cavity; a beam coupled between the mass portion and a side of the cavity; and a pair of sensing elements at a distal end of the beam away from the mass portion and being part of the beam or on two opposing sides of the beam; and a processing circuit coupled to the pair of sensing elements and configured to: receive first signals from the pair of sensing elements; and provide a second signal representing a measurement of a motion of the motion sensor based on the first signals.
Example 2 is an apparatus according to any example herein, in particular example 1, wherein side of the cavity is a first side of the cavity, the cavity has a second side opposing the first die, the mass portion has opposing first and second sides, the first side of the mass portion coupled to the first side of cavity via the beam, and the second side of the mass portion is decoupled from the second side of the cavity.
Example 3 is an apparatus according to any example herein, in particular example 1, wherein a width and a thickness of the beam are configured to facilitate a movement of the beam and the mass portion along a first direction perpendicular to a bottom of the cavity and to deter a movement of the beam and the mass portion along a second direction parallel with the bottom of the cavity.
Example 4 is an apparatus according to any example herein, in particular example 1, wherein a width and a thickness of the beam are configured to deter a movement of the beam and the mass portion along a first direction perpendicular to a bottom of the cavity and to facilitate a movement of the beam and the mass portion along a second direction parallel with the bottom of the cavity.
Example 5 is an apparatus according to any example herein, in particular example 1, wherein an end portion of the beam coupled to the side of the cavity has a reduced thickness than a middle portion of the beam between the end portion and then mass portion, and the pair of sensing elements are on the opposing sides of the end portion.
Example 6 is an apparatus according to any example herein, in particular example 5, wherein the end portion includes one or more through holes.
Example 7 is an apparatus according to any example herein, in particular example 1, wherein the pair of sensing elements includes a pair of piezoelectric layers.
Example 8 is an apparatus according to any example herein, in particular example 1, wherein the pair of sensing elements includes a pair of resistors.
Example 9 is an apparatus according to any example herein, in particular example 1, wherein the beam has a portion having non-parallel edges and a first width and a second width between the non-parallel edges, the first width proximate the mass portion and the second width at the distal end of the beam, the second width being larger than the first width, and the pair of sensing elements are between the non-parallel edges.
Example 10 is an apparatus according to any example herein, in particular example 1, wherein the beam is a first beam, the pair of sensing elements is a first pair of sensing elements, and the motion sensor further comprises a second beam coupled between the mass portion and the side of the cavity and a second pair of sensing elements at a distal end of the second beam away from the mass portion and on two opposing sides of the second beam.
Example 11 is an apparatus according to any example herein, in particular example 1, further comprising one or more devices in the cavity configured to restrict a movement of the mass portion.
Example 12 is an apparatus according to any example herein, in particular example 1, wherein the mass portion is a first mass portion, the beam is a first beam, the cavity is a first cavity, and the pair of sensing elements is a first pair of sensing elements, the semiconductor substrate further includes a second cavity, and the motion sensor includes: a second mass portion over a bottom of the second cavity; a second beam coupled between the second mass portion and a side of the second cavity; and a second pair of sensing elements at a distal end of the second beam away from the second mass portion and on two opposing sides of the second beam; and wherein the processing circuit is coupled to the second pair of sensing elements.
Example 13 is an apparatus according to any example herein, in particular example 11, wherein the first and second cavities are connected.
Example 14 is an apparatus according to any example herein, in particular example 11, wherein the first and second cavities are disconnected from each other.
Example 15 is an apparatus according to any example herein, in particular example 11, wherein the first beam and the second beam are orthogonal to each other.
Example 16 is an apparatus according to any example herein, in particular example 11, wherein the first beam and the second beam are parallel to each other.
Example 17 is an apparatus according to any example herein, in particular example 1, wherein the motion sensor includes a second substrate below the semiconductor substrate, and the second substrate provides the bottom of the cavity.
Example 18 is an apparatus according to any example herein, in particular example 17, wherein the second substrate includes a wafer level encapsulation material.
Example 19 is an apparatus according to any example herein, in particular example 1, wherein the side of the cavity is a first side, and the motion sensor includes an extension from a second side of the cavity opposing the first side, the extension forming a slit with the mass portion.
Example 20 is an apparatus according to any example herein, in particular example 1, wherein the motion sensor includes a plastic material on the beam.
Example 21 is an apparatus according to any example herein, in particular example 1, wherein the beam is a first beam, the side is a first side, the pair of sensing elements is a first pair of sensing elements, and the motion sensor further includes: a second beam coupled between the mass portion and a second side of the cavity opposing the first side; a second pair of sensing elements at a distal end of the second beam away from the mass portion and on two opposing sides of the second beam; a third beam coupled between the mass portion and a third side of the cavity; a third pair of sensing elements at a distal end of the third beam away from the mass portion and on two opposing sides of the third beam; a fourth beam coupled between the mass portion and a fourth side of the cavity opposing the third side; and a fourth pair of sensing elements at a distal end of the fourth beam away from the mass portion and on two opposing sides of the fourth beam; and wherein the processing circuit is coupled to the second, third, and fourth pairs of sensing elements.
Example 22 is an apparatus according to any example herein, in particular example 21, wherein the motion sensor further includes: a fifth beam coupled between the mass portion and the first side of the cavity; a fifth pair of sensing elements at a distal end of the fifth beam away from the mass portion and on two opposing sides of the fifth beam; a sixth beam coupled between the mass portion and the second side of the cavity; a sixth pair of sensing elements at a distal end of the sixth beam away from the mass portion and on two opposing sides of the sixth beam; a seventh beam coupled between the mass portion and the third side of the cavity; a seventh pair of sensing elements at a distal end of the seventh beam away from the mass portion and on two opposing sides of the seventh beam; an eighth beam coupled between the mass portion and the fourth side of the cavity; an eighth pair of sensing elements at a distal end of the eighth beam away from the mass portion and on two opposing sides of the eighth beam; and wherein the processing circuit is coupled to the fifth, sixth, seventh, and eighth pairs of sensing elements.
Example 23 is an apparatus according to any example herein, in particular example 22, wherein the mass portion is a first mass portion, and the motion sensor further includes a second mass portion, a third mass portion, a fourth mass portion, and a fifth mass portion coupled to first mass portion, the second mass portion is between the first and fifth beams, the third mass portion is between the second and sixth beams, the fourth mass portion is between the third and seventh beams, and the fifth mass portion is between the fourth and eighth beams.
Example 24 is an apparatus according to any example herein, in particular example 21, wherein the mass portion is a first mass portion having four corners, and the motion sensor further includes a second mass portion, a third mass portion, a fourth mass portion, and a fifth mass portion at the four corners of the first mass portion.
Example 25 is an apparatus according to any example herein, in particular example 21, wherein the side of the cavity is a first side of the cavity, and the motion sensor includes protrusion structures on the bottom of the cavity and first extension structures from a second side of the cavity overlapping a part of the mass portion; and wherein the mass portion includes second extension structures overlapping the protrusion structures.
Example 26 An apparatus comprising: a unidirectional shock sensor including: a substrate including a cavity; a mass portion over a bottom of the cavity; a beam coupled between the mass portion and a side of the cavity; and a pair of sensing elements at a distal end of the beam away from the mass portion and being part of the beam or on two opposing sides of the beam; and a processing circuit coupled to the pair of sensing elements and configured to: receive first signals from the pair of sensing elements; and provide a second signal representing a measurement of a motion of the unidirectional shock sensor based on the first signals.
Example 27 is an apparatus according to any example herein, in particular example 26, wherein side of the cavity is a first side of the cavity, the cavity has a second side opposing the first die, the mass portion has opposing first and second sides, the first side of the mass portion coupled to the first side of cavity via the beam, and the second side of the mass portion is decoupled from the second side of the cavity.
Example 28 is an apparatus according to any example herein, in particular example 26, wherein the beam has a portion having non-parallel edges and a first width and a second width between the non-parallel edges, the first width proximate the mass portion and the second width at the distal end of the beam, the second width being larger than the first width, and the pair of sensing elements are between the non-parallel edges.
Example 29 is an apparatus comprising: a voice accelerometer including: a substrate including a cavity; a mass portion adjacent to the cavity; a beam coupled between the mass portion and a side of the cavity; and a pair of sensing elements on the first beam near the mass portion and away from the side of the cavity; and a processing circuit coupled to the pair of sensing elements and configured to: receive a first signal from the pair of sensing elements, the first signal representing a measurement of a motion of the voice accelerometer; and provide an audio signal based on the first signal.
Example 30 is an apparatus according to any example herein, in particular example 29, wherein the beam is a first beam, the side is a first side, the pair of sensing elements is a first pair of sensing elements, and wherein the voice accelerometer includes: a second beam coupled between the mass portion and a second side of the cavity opposing the first side; a second pair of sensing elements on the second beam near the mass portion and away from the second side of the cavity; a third beam coupled between the mass portion and a third side of the cavity; a third pair of sensing elements on the third beam near the mass portion and away from the third side of the cavity; a fourth beam coupled between the mass portion and a fourth side of the cavity opposing the third side; and a fourth pair of sensing elements on the fourth beam near the mass portion and away from the fourth side of the cavity; and wherein the processing circuit is coupled to the second, third, and fourth pairs of sensing elements.
Example 31 is an apparatus according to any example herein, in particular example 30, wherein the voice accelerometer further includes: a fifth beam coupled between the mass portion and the first side of the cavity; a fifth pair of sensing elements on the fifth beam near the mass portion and away from the fifth side of the cavity; wherein the mass portion extends between the fifth beam and the first beam, and wherein the processing circuit is coupled to the fifth pairs of sensing elements.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuit. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN), or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means being within +/−10 percent of that parameter or, if the parameter is zero, a reasonable range of values around zero.

What is claimed is:

1. An apparatus comprising:
a motion sensor including:
a semiconductor substrate including a cavity;
a mass portion over a bottom of the cavity;
a beam coupled between the mass portion and a side of the cavity; and
a pair of sensing elements at a distal end of the beam away from the mass portion and being part of the beam or on two opposing sides of the beam; and
a processing circuit coupled to the pair of sensing elements and configured to:
receive first signals from the pair of sensing elements; and
provide a second signal representing a measurement of a motion of the motion sensor based on the first signals.

2. The apparatus of claim 1, wherein side of the cavity is a first side of the cavity, the cavity has a second side opposing the first side, the mass portion has opposing first and second sides, the first side of the mass portion coupled to the first side of cavity via the beam, and the second side of the mass portion is decoupled from the second side of the cavity.

3. The apparatus of claim 1, wherein a width and a thickness of the beam are configured to facilitate a movement of the beam and the mass portion along a first direction perpendicular to a bottom of the cavity and to deter a movement of the beam and the mass portion along a second direction parallel with the bottom of the cavity.

4. The apparatus of claim 1, wherein a width and a thickness of the beam are configured to deter a movement of the beam and the mass portion along a first direction perpendicular to a bottom of the cavity and to facilitate a movement of the beam and the mass portion along a second direction parallel with the bottom of the cavity.

5. The apparatus of claim 1, wherein an end portion of the beam coupled to the side of the cavity has a reduced thickness than a middle portion of the beam between the end portion and then mass portion, and the pair of sensing elements are on the opposing sides of the end portion.

6. The apparatus of claim 5, wherein the end portion includes one or more through holes.

7. The apparatus of claim 1, wherein the pair of sensing elements includes a pair of piezoelectric layers.

8. The apparatus of claim 1, wherein the pair of sensing elements includes a pair of resistors.

9. The apparatus of claim 1, wherein the beam has a portion having non-parallel edges and a first width and a second width between the non-parallel edges, the first width proximate the mass portion and the second width at the distal end of the beam, the second width being larger than the first width, and the pair of sensing elements are between the non-parallel edges.

10. The apparatus of claim 1, wherein the beam is a first beam, the pair of sensing elements is a first pair of sensing elements, and the motion sensor further comprises a second beam coupled between the mass portion and the side of the cavity and a second pair of sensing elements at a distal end of the second beam away from the mass portion and on two opposing sides of the second beam.

11. The apparatus of claim 1, further comprising one or more devices in the cavity configured to restrict a movement of the mass portion.

12. The apparatus of claim 1, wherein the mass portion is a first mass portion, the beam is a first beam, the cavity is a first cavity, and the pair of sensing elements is a first pair of sensing elements, the semiconductor substrate further includes a second cavity, and the motion sensor includes:
a second mass portion over a bottom of the second cavity;
a second beam coupled between the second mass portion and a side of the second cavity; and
a second pair of sensing elements at a distal end of the second beam away from the second mass portion and on two opposing sides of the second beam; and
wherein the processing circuit is coupled to the second pair of sensing elements.

13. The apparatus of claim 11, wherein the first and second cavities are connected.

14. The apparatus of claim 11, wherein the first and second cavities are disconnected from each other.

15. The apparatus of claim 11, wherein the first beam and the second beam are orthogonal to each other.

16. The apparatus of claim 11, wherein the first beam and the second beam are parallel to each other.

17. The apparatus of claim 1, wherein the motion sensor includes a second substrate below the semiconductor substrate, and the second substrate provides the bottom of the cavity.

18. The apparatus of claim 17, wherein the second substrate includes a wafer level encapsulation material.

19. The apparatus of claim 1, wherein the side of the cavity is a first side, and the motion sensor includes an extension from a second side of the cavity opposing the first side, the extension forming a slit with the mass portion.

20. The apparatus of claim 1, wherein the motion sensor includes a material on the beam.

21. The apparatus of claim 1, wherein the beam is a first beam, the side is a first side, the pair of sensing elements is a first pair of sensing elements, and the motion sensor further includes:
a second beam coupled between the mass portion and a second side of the cavity opposing the first side;
a second pair of sensing elements at a distal end of the second beam away from the mass portion and on two opposing sides of the second beam;
a third beam coupled between the mass portion and a third side of the cavity;
a third pair of sensing elements at a distal end of the third beam away from the mass portion and on two opposing sides of the third beam;
a fourth beam coupled between the mass portion and a fourth side of the cavity opposing the third side; and
a fourth pair of sensing elements at a distal end of the fourth beam away from the mass portion and on two opposing sides of the fourth beam; and
wherein the processing circuit is coupled to the second, third, and fourth pairs of sensing elements.

22. The apparatus of claim 21, wherein the motion sensor further includes:
a fifth beam coupled between the mass portion and the first side of the cavity;
a fifth pair of sensing elements at a distal end of the fifth beam away from the mass portion and on two opposing sides of the fifth beam;
a sixth beam coupled between the mass portion and the second side of the cavity;
a sixth pair of sensing elements at a distal end of the sixth beam away from the mass portion and on two opposing sides of the sixth beam;
a seventh beam coupled between the mass portion and the third side of the cavity;
a seventh pair of sensing elements at a distal end of the seventh beam away from the mass portion and on two opposing sides of the seventh beam;
an eighth beam coupled between the mass portion and the fourth side of the cavity;
an eighth pair of sensing elements at a distal end of the eighth beam away from the mass portion and on two opposing sides of the eighth beam; and
wherein the processing circuit is coupled to the fifth, sixth, seventh, and eighth pairs of sensing elements.

23. The apparatus of claim 22, wherein the mass portion is a first mass portion, and the motion sensor further includes a second mass portion, a third mass portion, a fourth mass portion, and a fifth mass portion coupled to first mass portion, the second mass portion is between the first and fifth beams, the third mass portion is between the second and sixth beams, the fourth mass portion is between the third and seventh beams, and the fifth mass portion is between the fourth and eighth beams.

24. The apparatus of claim 21, wherein the mass portion is a first mass portion having four corners, and the motion sensor further includes a second mass portion, a third mass portion, a fourth mass portion, and a fifth mass portion at the four corners of the first mass portion.

25. The apparatus of claim 21, wherein the side of the cavity is a first side of the cavity, and the motion sensor includes protrusion structures on the bottom of the cavity and first extension structures from a second side of the cavity overlapping a part of the mass portion; and
wherein the mass portion includes second extension structures overlapping the protrusion structures.

26. An apparatus comprising:
a unidirectional shock sensor including:
a substrate including a cavity;
a mass portion over a bottom of the cavity;
a beam coupled between the mass portion and a side of the cavity; and
a pair of sensing elements at a distal end of the beam away from the mass portion and being part of the beam or on two opposing sides of the beam; and
a processing circuit coupled to the pair of sensing elements and configured to:
receive first signals from the pair of sensing elements; and
provide a second signal representing a measurement of a motion of the unidirectional shock sensor based on the first signals.

27. The apparatus of claim 26, wherein side of the cavity is a first side of the cavity, the cavity has a second side opposing the first side, the mass portion has opposing first and second sides, the first side of the mass portion coupled to the first side of cavity via the beam, and the second side of the mass portion is decoupled from the second side of the cavity.

28. The apparatus of claim 26, wherein the beam has a portion having non-parallel edges and a first width and a second width between the non-parallel edges, the first width proximate the mass portion and the second width at the distal end of the beam, the second width being larger than the first width, and the pair of sensing elements are between the non-parallel edges.

29. An apparatus comprising
a voice accelerometer including:
a substrate including a cavity;
a mass portion adjacent to the cavity;
a beam coupled between the mass portion and a side of the cavity; and
a pair of sensing elements on the beam near the mass portion and away from the side of the cavity; and
a processing circuit coupled to the pair of sensing elements and configured to:
receive a first signal from the pair of sensing elements, the first signal representing a measurement of a motion of the voice accelerometer; and
provide an audio signal based on the first signal.

30. The apparatus of claim 29, wherein the beam is a first beam, the side is a first side, the pair of sensing elements is a first pair of sensing elements, and wherein the voice accelerometer includes:
a second beam coupled between the mass portion and a second side of the cavity opposing the first side;
a second pair of sensing elements on the second beam near the mass portion and away from the second side of the cavity;
a third beam coupled between the mass portion and a third side of the cavity;
a third pair of sensing elements on the third beam near the mass portion and away from the third side of the cavity;
a fourth beam coupled between the mass portion and a fourth side of the cavity opposing the third side; and
a fourth pair of sensing elements on the fourth beam near the mass portion and away from the fourth side of the cavity; and
wherein the processing circuit is coupled to the second, third, and fourth pairs of sensing elements.

31. The apparatus of claim 30, wherein the voice accelerometer further includes:
a fifth beam coupled between the mass portion and the first side of the cavity;
a fifth pair of sensing elements on the fifth beam near the mass portion and away from the fifth side of the cavity;
wherein the mass portion extends between the fifth beam and the first beam, and
wherein the processing circuit is coupled to the fifth pair of sensing elements.
